(19) United States
(12) Patent Application Publication
(10) Pub. No.: US 2016/0308870 A1
(43) Pub. Date: Oct. 20, 2016

(54) NETWORK ACCESS METHOD AND APPARATUS

(71) Applicant: HUAWEI DEVICE CO., LTD., Shenzhen (CN)

(72) Inventors: Yunsheng KUANG, Shenzhen (CN); Yajun ZHANG, Shenzhen (CN); Yu ZHU, Shenzhen (CN)

(73) Assignee: HUAWEI DEVICE CO., LTD., Shenzhen (CN)

(21) Appl. No.: 15/191,987

(22) Filed: Jun. 24, 2016

Related U.S. Application Data
(63) Continuation of application No. PCT/CN2014/094886, filed on Dec. 25, 2014.

(30) Foreign Application Priority Data
Dec. 25, 2013 (CN) 201310726378.5

(51) Int. Cl. H04L 29/06; H04W 12/02

(52) U.S. Cl. CPC H04L 63/10; H04W 12/02; H04L 63/101

(57) ABSTRACT

Embodiments of the present invention disclose a network access method including: after a terminal device is connected to a first network, acquiring, by the terminal device, identification information of or a media file on a device on a second network; determining a sharing mode according to a property of the first network, and determining, according to the sharing mode, shared data that needs to be sent to a device on the first network, where the shared data includes the device or media file on the second network, and/or a media file on the terminal device; and acquiring an announcement message according to the sharing mode and advertising the announcement message to the first network. The present invention applies to ensuring network access security.

### CROSS-REFERENCE TO RELATED APPLICATIONS

This application is a continuation of International Application No. PCT/CN2014/094886, filed on Dec. 25, 2014, which claims priority to Chinese Patent Application No. 201310726378.5, filed on Dec. 25, 2013, both of which are hereby incorporated by reference in their entireties.

### TECHNICAL FIELD

The present invention relates to the field of electronic information technologies, and in particular, to a network access method and apparatus.

### BACKGROUND

With rapid development of electronic information technologies such as a remote access technology and a cloud technology, a network media device located on a local area network may implement, by means of remote access and in a data transmission manner that is based on the cloud technology, interconnection and media content sharing with another local area network. For example, a limit of a local area network may be broken through by using a Digital Living Network Alliance (DLNA) technology, implementing media content sharing among multiple local area networks.

During application of a current DLNA technology, communication may be implemented between a local area network 1 and a local area network 2 by using a cloud server as a data channel After being connected to the local area network 2 by using the cloud server, an remote access client (RAC) on the local area network 1 not only can discover an remote access server (RAS) on the local area network 2 but also can learn of another DLNA device on the local area network 2 by using information advertised by the RAS. After this, the RAC advertises a status of the DLNA device, learned of by the RAC, on the local area network 2 to devices on the local area network 1, so that devices on the two local area networks connected by using the cloud server can discover each other. This is equivalent to that two different local area networks are integrated into one network. Therefore, quick and highly-efficient communication or mutual data calling between devices on the different local area networks can be implemented.

Although the DLNA technology implements quick and highly-efficient data exchange between the devices on the different local area networks, there are potential security problems. For example, the local area network 2 is a home network of a user, and after the user carries an RAC to arrive in an unfamiliar environment, the RAC discovers the local area network 1 in the unfamiliar environment and is connected to the local area network 1. In this case, the user may connect the RAC to the local area network 2 by using a cloud server and search for private data on a DLNA device on the local area network 2. In this case, the RAC advertises statuses, learned of by the RAC, of DLNA devices on the local area network 2 to devices on the local area network 1, so that, another device on the local area network 1 can easily call data from a DLNA device on the local area network 2, which results in theft of private data stored on the home network by the user, thereby disclosing privacy of the user and reducing security during network access.

### SUMMARY

Embodiments of the present invention provide a network access method and apparatus, which can prevent, when a terminal device is on an unfamiliar network and a user uses the terminal device to access a private network, another device on the unfamiliar network from maliciously accessing the private network, thereby protecting user privacy and improving security during network access.

To achieve the foregoing objective, the following technical solutions are used in the embodiments of the present invention:

According to a first aspect, an embodiment of the present invention provides a network access method, including:

after a terminal device is connected to a first network, acquiring, by the terminal device, identification information of or a media file on a device on a second network;

determining a sharing mode according to a property of the first network, and determining, according to the sharing mode, shared data that needs to be sent to a device on the first network, where the shared data includes the device or media file on the second network, and/or a media file on the terminal device; and

advertising an announcement message to the first network according to the sharing mode, where the announcement message includes at least one of the following: access interface information of the device on the second network, access interface information of the media file on the second network, and access interface information of the media file on the terminal device.

With reference to the first aspect, in a first possible implementation manner of the first aspect, the method further includes: determining, according to the sharing mode, to skip sending the announcement message to the first network; and blocking a search request message that is from the first network, where the search request message is used to request, from the mobile terminal, the access interface information of the device on the second network, the access interface information of the media file on the second network, or the access interface information of the media file on the terminal device.

With reference to the first aspect or the first possible implementation manner of the first aspect, in a second possible implementation manner, the sharing mode includes:

sending, by the terminal device, a first announcement message to the first network, where the first announcement message includes the access interface information of the device on the second network, the access interface information of the media file on the second network, and the access interface information of the media file on the terminal device; or

sending, by the terminal device, a second announcement message to the first network, where the second announcement message includes the access interface information of the media file on the terminal device; or

blocking, by the terminal device, the search request message that is from the first network.

With reference to the first aspect, in a third possible implementation manner of the first aspect, the determining a sharing mode according to a property of the first network includes:

acquiring a security level of the first network according to a service set identifier (SSID) of the first network and/or access mode information of the first network; and

determining the sharing mode according to the security level of the first network.

With reference to the first aspect and the second and third possible implementation manners of the first aspect, in a fourth possible implementation manner of the first aspect, the advertising an announcement message to the first network according to the sharing mode includes:

acquiring a first advertising list and access interface information of a media file recorded in the first advertising list, where at least one media file on the mobile terminal is recorded in the first advertising list; and

generating the first announcement message according to the access interface information of the media file recorded in the first advertising list, and sending the first announcement message to the first network.

With reference to the first aspect and the second to fourth possible implementation manners of the first aspect, in a fifth possible implementation manner of the first aspect, the advertising an announcement message to the first network according to the sharing mode further includes:

acquiring a second advertising list and access interface information of a media file recorded in the second advertising list, where at least one of the identification information of the device on the second network and the media file on the second network is recorded in the second advertising list; and

generating the second announcement message according to the second advertising list and the access interface information of the media file recorded in the second advertising list, and sending the second announcement message to the first network.

According to a second aspect, an embodiment of the present invention provides a network access apparatus, including:

a data management module, configured to: after a terminal device is connected to a first network, acquire identification information of or a media file on a device on a second network;

a network analysis module, configured to determine a sharing mode according to a property of the first network, and determine, according to the sharing mode, shared data that needs to be sent to a device on the first network, where the shared data includes the device or media file on the second network, and/or a media file on the terminal device; and

an advertising module, configured to advertise an announcement message to the first network according to the sharing mode, where the announcement message includes at least one of the following: access interface information of the device on the second network, access interface information of the media file on the second network, and access interface information of the media file on the terminal device.

With reference to the second aspect, in a first possible implementation manner of the second aspect, the apparatus further includes:

a blocking module, configured to determine, according to the sharing mode, to skip sending the announcement message to the first network; and block a search request message that is from the first network, where the search request message is used to request, from the mobile terminal, the access interface information of the device on the second network, the access interface information of the media file on the second network, or the access interface information of the media file on the terminal device.

With reference to the second aspect or the first possible implementation manner of the second aspect, in a second possible implementation manner, the sharing mode includes:

sending, by the terminal device, a first announcement message to the first network, where the first announcement message includes the access interface information of the device on the second network, the access interface information of the media file on the second network, and the access interface information of the media file on the terminal device; or

sending, by the terminal device, a second announcement message to the first network, where the second announcement message includes the access interface information of the media file on the terminal device; or

blocking, by the terminal device, the search request message that is from the first network.

With reference to the second aspect, in a third possible implementation manner of the second aspect, the network analysis module includes:

a security level determining unit, configured to acquire a security level of the first network according to a service set identifier (SSID) of the first network and/or access mode information of the first network; and

a mode determining unit, configured to determine the sharing mode according to the security level of the first network.

With reference to the second aspect and the second and third possible implementation manners of the second aspect, in a fourth possible implementation manner of the second aspect, the network analysis module includes:

a first analysis unit, configured to acquire a first advertising list and access interface information of a media file recorded in the first advertising list, where at least one media file on the mobile terminal is recorded in the first advertising list; and

a first message generation unit, configured to generate the first announcement message according to the access interface information of the media file recorded in the first advertising list, and send the first announcement message to the first network.

With reference to the second aspect and the second to fourth possible implementation manners of the second aspect, in a fifth possible implementation manner of the second aspect, the network analysis module further includes:

a second analysis unit, configured to acquire a second advertising list and access interface information of a media file recorded in the second advertising list, where at least one of the identification information of the device on the second network and the media file on the second network is recorded in the second advertising list; and

a second message generation unit, configured to generate the second announcement message according to the second advertising list and the access interface information of the media file recorded in the second advertising list, and send the second announcement message to the first network.

According to the network access method and apparatus provided in the embodiments of the present invention, a property of a network on which a terminal device is currently located can be determined, and the terminal device advertises, only when the network on which the terminal device is currently located is secure enough, a device and a media file on a remotely connected network to the network on which the terminal device is currently located; if the network on which the terminal device is currently located is not secure enough, the terminal device performs no advertising. Compared with a solution in the prior art in which all devices on a private network are advertised to an unfamiliar network to implement totally transparent transmission between different networks, in the embodiments of the present invention, security assessment may be performed on an unfamiliar network and whether a device and a media file on a private network and a media file on a terminal device need to be advertised to the unfamiliar network may be determined; therefore the terminal device can reduce a possibility of advertising a device on the private network to an insecure network, thereby reducing a possibility that a device on a private network is maliciously accessed by a device on an insecure network, ensuring user privacy, and improving security during network access. In addition, in the embodiments of the present invention, the terminal device may further select different advertising policies according to a property of the network on which the terminal device is currently located; therefore, the terminal device may use a more flexible security policy with respect to an unfamiliar network on which the terminal device is currently located, thereby reducing, when ensuring information sharing, a possibility that an important device on a private network is maliciously accessed by a device on an unfamiliar network. Therefore, compared with the prior art, the embodiments of the present invention can further protect an important device on a private network when ensuring that a user normally uses a network on which a terminal device is located, which further improves security during network access. In the embodiments of the present invention, the terminal device may further set a limit to a shared status of data on the private network, and after the device on the private network is advertised, can further protect the advertised data on the device, thereby reducing a possibility that the advertised data, involving user privacy, stored on the device is accessed. Therefore, compared with the prior art, the embodiments of the present invention can, when ensuring that a terminal device normally advertises a device on a private network, further reduce a possibility that important data on the private network is maliciously acquired, thereby further protecting user privacy and improving security during network access.

### BRIEF DESCRIPTION OF DRAWINGS

To describe the technical solutions in the embodiments of the present invention more clearly, the following briefly introduces the accompanying drawings required for describing the embodiments. Apparently, the accompanying drawings in the following description show merely some embodiments of the present invention, and a person of ordinary skill in the art may still derive other drawings from these accompanying drawings without creative efforts.

FIG. 1 is a schematic diagram of a network architecture according to an embodiment of the present invention;

FIG. 2a and FIG. 2b are schematic flowcharts of a network access method according to an embodiment of the present invention;

FIG. 3a, FIG. 3b, FIG. 3c, and FIG. 3d are schematic flowcharts of specific examples according to an embodiment of the present invention;

FIG. 4 is a schematic flowchart of another network access method according to an embodiment of the present invention;

FIG. 5 and FIG. 6 are schematic flowcharts of still another network access method according to an embodiment of the present invention;

FIG. 7 is a schematic flowchart of yet another network access method according to an embodiment of the present invention;

FIG. 8 is a schematic structural diagram of a network access apparatus according to an embodiment of the present invention;

FIG. 9 is a schematic structural diagram of another network access apparatus according to an embodiment of the present invention;

FIG. 10 is a schematic structural diagram of still another network access apparatus according to an embodiment of the present invention; and

FIG. 11 is a schematic structural diagram of a terminal device according to an embodiment of the present invention.

### DESCRIPTION OF EMBODIMENTS

The following clearly describes the technical solutions in the embodiments of the present invention with reference to the accompanying drawings in the embodiments of the present invention. Apparently, the described embodiments are merely some but not all of the embodiments of the present invention. All other embodiments obtained by a person of ordinary skill in the art based on the embodiments of the present invention without creative efforts shall fall within the protection scope of the present invention.

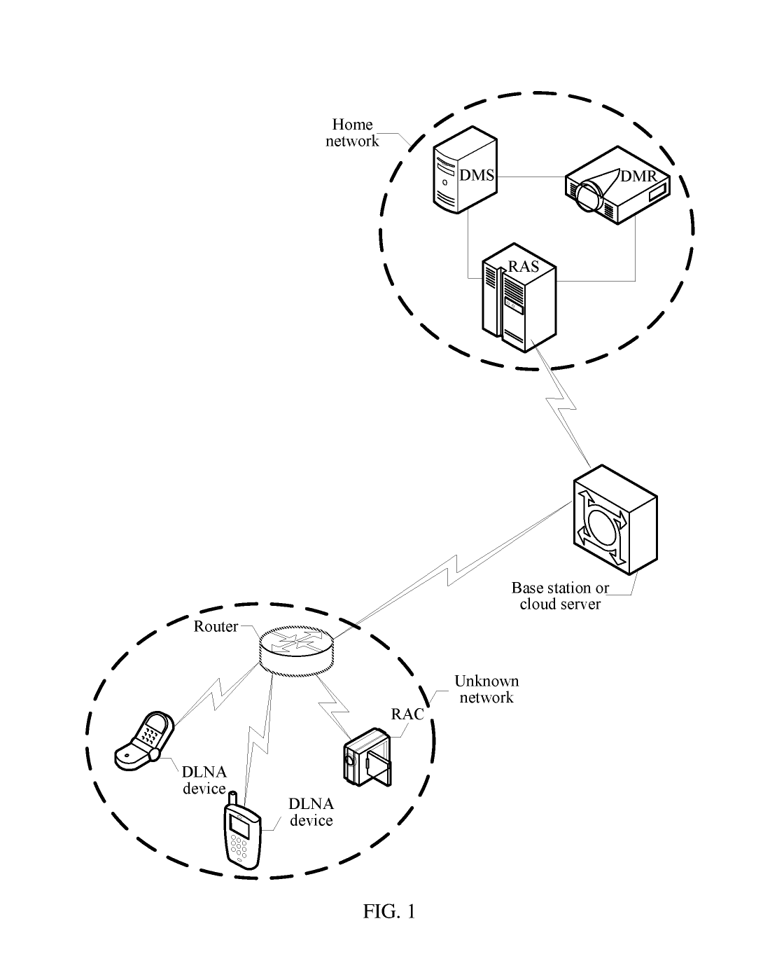

The embodiments of the present invention may be applied to a network system including multiple local area networks. A terminal device on a first network in the network system may be connected to a second network in the network system. For example, a network system shown in FIG. 1 includes an unknown network and a home network, where the unknown network may be used as a first network, and the home network may be used as a second network. The unknown network may include a device such as another terminal, a server, or a router. When a user carries a terminal device, used as an RAC, to enter coverage of the unknown network, the RAC may be connected to the unknown network automatically or according to an instruction of the user, for example, automatically establish a connection to the router on the unknown network. The home network may be a private network of the user, and a node device on the home network stores private data of the user. The RAC may be specifically implemented as a terminal device on which a client program used for implementing a DLNA RAC function is installed. The terminal device may be specifically a smartphone, a notebook computer, a PAD, a digital camera, or the like. For example, a user carries a smartphone, used as an RAC, to leave home and arrive at an airport. A wireless network including DLNA devices such as an RAS, a digital media server (DMS), and a digital media renderer (DMR) in a dwelling is a home network, and a DLNA device included on the home network may be used as a node device on the second network. A wireless network provided at the airport is an unknown network, and in addition to the RAC of the user, a device such as a smartphone, a computer, or a PAD of another person is also connected to the wireless network provided at the airport.

When the user wants to access the home network by using the RAC and extract the private data, the RAC may be connected, according to an instruction of the user by using a wireless signal of the unknown network, to a device such as a cloud server or a base station used for forwarding a signal transmitted by the RAC, and may be remotely connected to the home network by using a device such as a cloud server or a base station, so as to acquire the private data from the DLNA device on the home network.

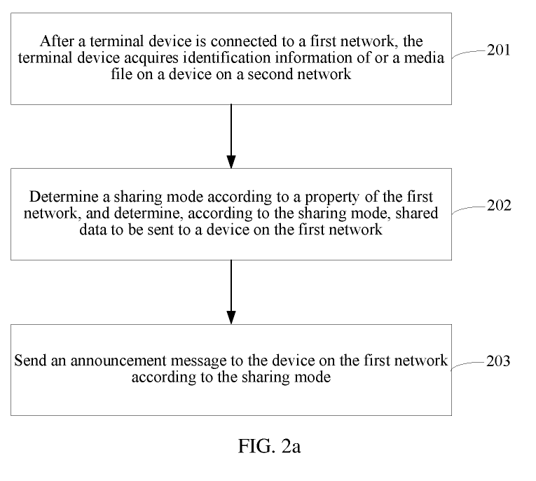

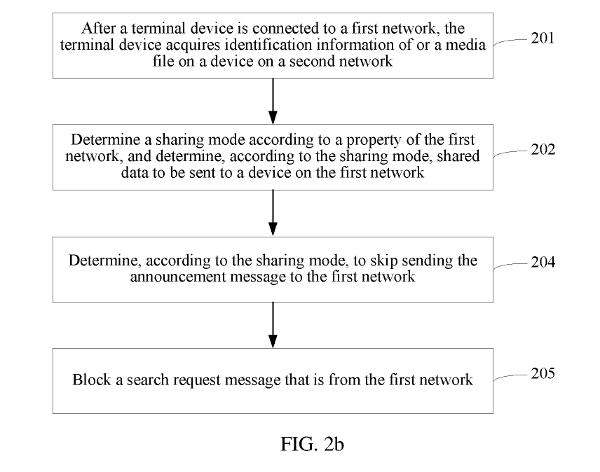

An embodiment of the present invention provides a network access method. As shown in FIG. 2a, the method may include:

201: After a terminal device is connected to a first network, the terminal device acquires identification information of or a media file on a device on a second network.

For example, the terminal device is on the first network, and then the terminal device may be used as a DLNA device, on the first network, integrating a remote access client, and is represented as a DLNA RAC device. The terminal device, serving as the DLNA RAC, can establish a remote access connection to a DLNA RAS on the second network by using a device such as a cloud server or a base station. At the same time that the terminal device may be used as a DLNA device on the first network, the terminal device may be used as a DLNA device on the second network. The DLNA RAS may be a device, on the second network, integrating a DMC function and a DLNA function, for example, a home media gateway integrating a DLNA function. The DLNA RAS can discover another DLNA device on the second network and may establish a remote access connection to the DLNA RAC on the first network.

After being remotely connected to the second network, a mobile terminal may acquire identification information of a physical device such as a server or a personal computer on the second network or identification information of a virtual machine established by each physical device on the second network, and may acquire a media file stored on each device on the second network. In this embodiment, the media file may include an audio/video file, an audio file, a picture file, an e-book, and the like. Specifically, the identification information may be information such as a device identifier, name information, a hardware number, or the like.

202: Determine a sharing mode according to a property of the first network, and determine, according to the sharing mode, shared data that needs to be sent to a device on the first network.

The shared data includes the device or media file on the second network, and/or a media file on the terminal device.

In this embodiment, the property of the first network may be a quantization parameter used to describe a status of the first network. The property of the first network may be specifically a parameter such as a name, a network type, a security level, a quantity of times of being attacked, a data volume of malicious data, or a quantity of times of sending malicious information of the first network. For example,

The first network is a subnet in a network system, and then the terminal device may acquire, from a security center of the network system, an assessment report for the property of the first network, may perform weighting calculation on parameters, such as a quantity of times of being attacked, a data volume of malicious data, and a quantity of times of sending malicious information, in the assessment report to obtain a quantization parameter X used to represent the property of the first network, and may determine, according to a relationship between the quantization parameter X and a confidence interval, whether data on a node device on the second network needs to be advertised to the first network. For example, an advertising rule may be shown in Table 1.

TABLE 1

| | Quantization parameter X | | |
|---|---|---|---|
| | (0, 5] | (5, 10] | (10, 15] |
| Advertising rule | Not advertised | Only a terminal | All advertised |
| | | device advertised | |

When the quantization parameter X is within (0, 5], the terminal device advertises no data to the first network; when the quantization parameter X is within (5, 10], the terminal device advertises, to the first network, only a media file stored on the terminal device; and when the quantization parameter X is within (10, 15], the terminal device advertises data on the node device on the second network, a media file stored on the second network, and a media file stored on the terminal device.

For another example, the property of the first network may be specifically represented as a security level, where the security level of the first network may be advertised by a security center in a network system; may be determined by a mobile terminal, where, for example, a security level of the first network may be graded according to name information or identifier information of the first network; or may be set by a user, as shown in Table 2.

TABLE 2

| | Security level | | |
|---|---|---|---|
| | Level 1 | Level 2 | Level 3 |
| Whether to be | Not advertised | Not advertised | All advertised |
| advertised | | | |

Shared data is advertised to the first network only when the security level of the first network reaches Level 3.

203: Advertise an announcement message to the first network according to the sharing mode.

The announcement message includes at least one of the following: access interface information of the device on the second network, access interface information of the media file on the second network, and access interface information of the media file on the terminal device.

If it is determined that no shared data is advertised to the first network, the mobile terminal performs no processing on a request message sent by the first network. In this embodiment, the request message sent by the first network is used to make a request to the mobile terminal to access the media file on the mobile terminal, the device on the second network, or the media file on the second network.

Alternatively, as shown in FIG. 2b, in this embodiment, the method may further include:

204: Determine, according to the sharing mode, to skip sending the announcement message to the first network.

205: Block a search request message that is from the first network.

The search request message is used to request, from the mobile terminal, the access interface information of the device on the second network, the access interface information of the media file on the second network, or the access interface information of the media file on the terminal device.

According to the network access method provided in this embodiment of the present invention, a property of a network on which a terminal device is currently located can be determined, and the terminal device advertises, only when the network on which the terminal device is currently located is secure enough, a device and a media file on a remotely connected network to the network on which the terminal device is currently located; if the network on which the terminal device is currently located is not secure enough, the terminal device performs no advertising. Compared with a solution in the prior art in which all devices on a private network are advertised to an unfamiliar network to implement totally transparent transmission between different networks, in this embodiment of the present invention, security assessment may be performed on an unfamiliar network and whether a device and a media file on a private network and a media file on a terminal device need to be advertised to the unfamiliar network may be determined; therefore the terminal device can reduce a possibility of advertising a device on the private network to an insecure network, thereby reducing a possibility that a device on a private network is maliciously accessed by a device on an insecure network, ensuring user privacy, and improving security during network access.

Optionally, in this embodiment, an implementation manner of the sharing mode may at least include:

sending, by the terminal device, a first announcement message to the first network, where the first announcement message includes the access interface information of the device on the second network, the access interface information of the media file on the second network, and the access interface information of the media file on the terminal device; or

sending, by the terminal device, a second announcement message to the first network, where the second announcement message includes the access interface information of the media file on the terminal device; or

blocking, by the terminal device, the search request message that is from the first network.

For example, the sharing mode may be specifically:

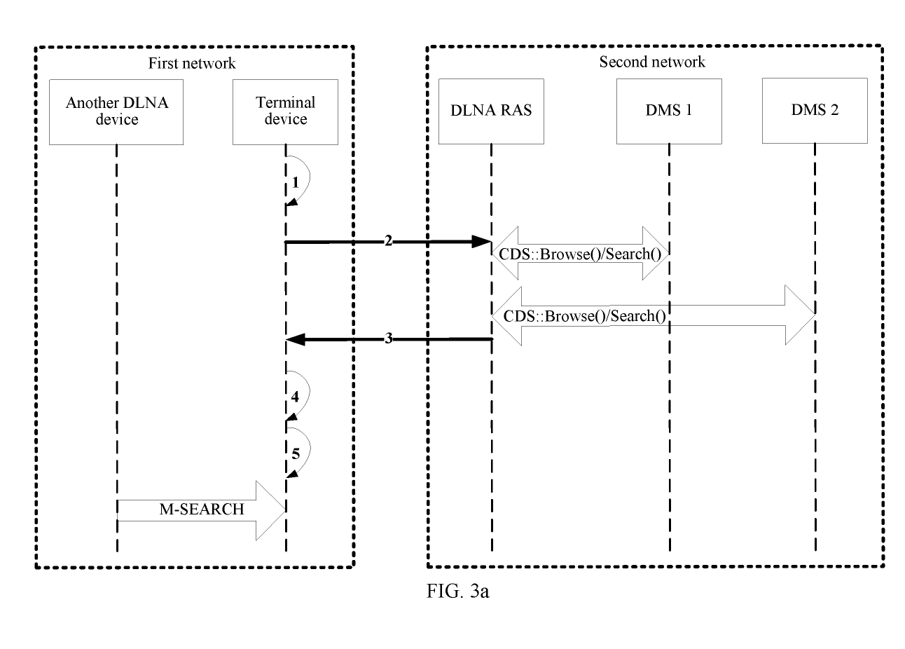

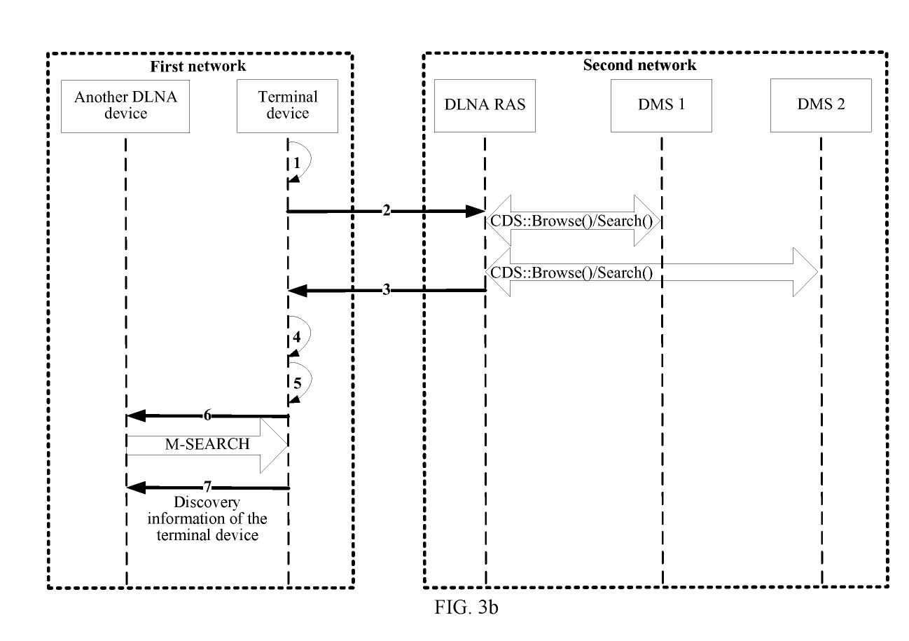

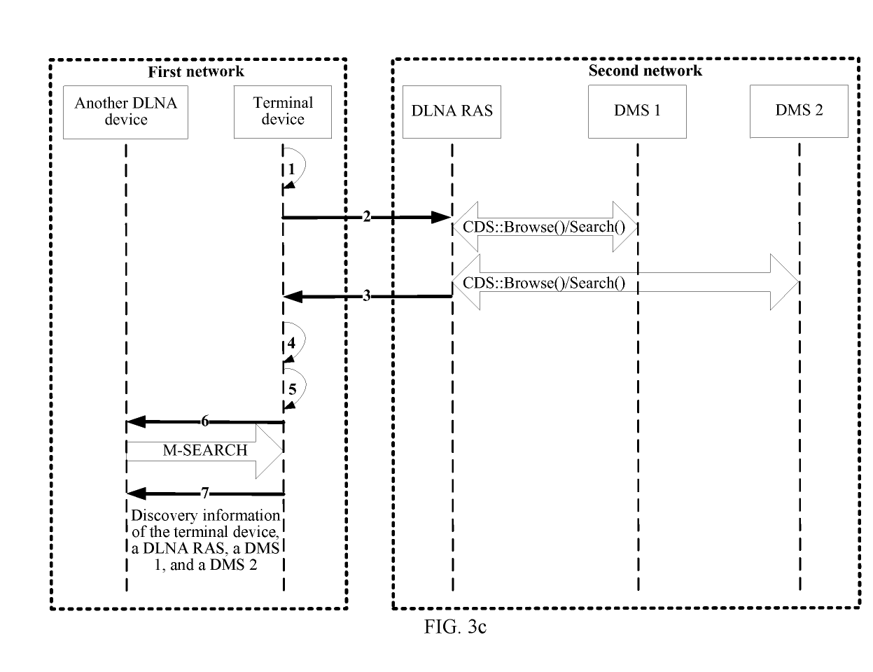

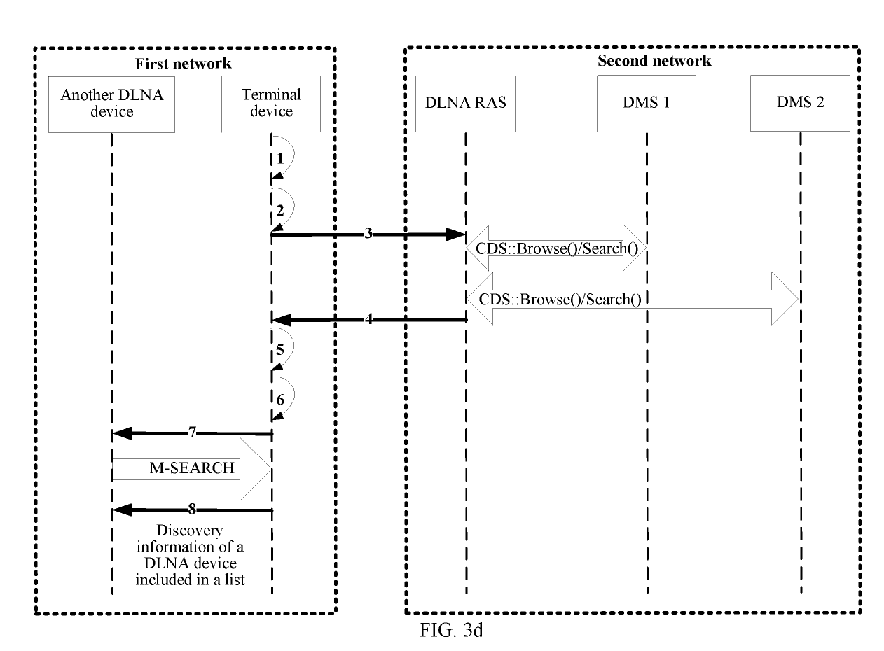

Common mode: The common mode may be used for a situation in which the terminal device advertises no data on any node device on the second network to the first network. As shown in FIG. 3a, a specific implementation solution of the common mode may include:

1. After the terminal device, serving as a DLNA RAC, is connected to the first network, the common mode is enabled.

2. After the terminal device is connected to the second network, the terminal device sends an access request to a DLNA RAS on the second network and may display, by using a user interface UI, media lists stored by the terminal device and a remote device.

3. After receiving the access request sent by the terminal device, the DLNA RAS may discover a node device on the second network by using a specific data exchange command, for example, CDS::Browse( )/Search( ) and notify the terminal device of the discovered node device by using a feedback message.

4. Receive the feedback message from the DLNA RAS and learn of each node device, for example, node devices such as a DMS 1 and a DMS 2 shown in FIG. 3a, on the second network from the feedback message. It should be noted that after learning of each node device on the second network, the terminal device may request data on the node device from the DLNA RAS, so as to implement a function of normally accessing the second network by the terminal device serving as the DLNA RAC.

5. In the common mode, the terminal device may disable a DLNA function of the terminal device, broadcast no SSDP device or service discovery message to the first network, and make no response after receiving an M-SEARCH request message sent by another DLNA device on the first network, so that the another DLNA device cannot discover the DLNA RAC, thereby avoiding advertising, by the terminal device, any node device on the second network to the first network.

Temporary mode: The temporary mode may be used for a situation in which data on some node devices on the second network need to be advertised to the first network. The terminal device may compare a service set identifier (SSID) of the first network and name information of a device on the first network with a security report released by a security center of a network system, to learn that the first network is secure. However, when connected to the first network, the terminal device finds that no password is set for the first network; therefore, a potential security problem still exists on the first network, and the temporary mode may be used. Specifically, as shown in FIG. 3b, a specific implementation solution of the temporary mode may include:

1. After the terminal device, serving as a DLNA RAC, is connected to the first network, the temporary mode is enabled.

2. After the terminal device is connected to the second network, the terminal device sends an access request to a DLNA RAS on the second network and may display, by using a user interface UI, media lists stored by the terminal device and a remote device.

3. After receiving the access request sent by the terminal device, the DLNA RAS may discover a node device on the second network by using a specific data exchange command, for example, CDS::Browse( )/Search( ) and notify the terminal device of the discovered node device by using a feedback message.

4. Receive the feedback message from the DLNA RAS and learn of each node device on the second network from the feedback message. It should be noted that after learning of each node device on the second network, the terminal device may request data on the node device from the DLNA RAS, so as to implement a function of normally accessing the second network by the terminal device serving as the DLNA RAC.

5. The terminal device, serving as the DLNA RAC, may enable a DLNA function of the terminal device.

6. The terminal device advertises shared data to the first network and broadcasts, by using the shared data, information about the terminal device to another DLNA device on the first network instead of broadcasting data on another DLNA device on the second network.

7. For an M-SEARCH request sent by a DLNA device on the first network, the terminal device responds only with discovery information of the terminal device.

Trusted mode: As shown in FIG. 3c, a specific implementation solution of the trusted mode may include:

1. After the terminal device, serving as a DLNA RAC, is connected to the first network, the trusted mode is enabled.

2. After the terminal device is connected to the second network, the terminal device sends an access request to a DLNA RAS on the second network and may display, by using a user interface UI, media lists stored by the terminal device and a remote device.

3. After receiving the access request sent by the terminal device, the DLNA RAS may discover a node device on the second network by using a specific data exchange command, for example, CDS::Browse( )/Search( ) and notify the terminal device of the discovered node device by using a feedback message.

4. Receive the feedback message from the DLNA RAS and learn of each node device on the second network from the feedback message. It should be noted that after learning of each node device on the second network, the terminal device may request data on the node device from the DLNA RAS, so as to implement a function of normally accessing the second network by the terminal device serving as the DLNA RAC.

5. The terminal device, serving as the DLNA RAC, enables a DLNA function of the terminal device.

6. The terminal device advertises shared data to the first network and broadcasts, by using the shared data, information about the terminal device to the first network and information about another DLNA device on the second network.

7. For an M-SEARCH request sent by a DLNA device on the first network, the terminal device may respond with discovery information of the terminal device and the DLNA device on the second network. For example, in FIG. 3c, if node devices on the second network are the DLNA RAS, a DMS 1, and a DMS 2, the terminal device may respond with discovery information of the terminal device, the DLNA RAS, the DMS 1, and the DMS 2.

Customized mode: The terminal device, serving as a DLNA RAC, may receive configuration information entered by a user. The configuration information may be specifically expressed by using a list, and the list may include some of all DLNA devices, including the terminal device, on the second network. As shown in FIG. 3d, a specific implementation solution of the customized mode may include:

1. After the terminal device, serving as the DLNA RAC, is connected to the first network, the customized mode is enabled.

2. The terminal device acquires the list, and a DLNA device that is on the second network and that needs to advertise data to the first network is recorded in the list.

3. After the terminal device is connected to the second network, the terminal device sends an access request to a DLNA RAS on the second network.

4. After receiving the access request sent by the terminal device, the DLNA RAS may discover a node device on the second network by using a specific data exchange command, for example, CDS::Browse( )/Search( ) and notify the terminal device of the discovered node device by using a feedback message.

5. Receive the feedback message from the DLNA RAS and learn of each node device on the second network from the feedback message. It should be noted that after learning of each node device on the second network, the terminal device may request data on the node device from the DLNA RAS, so as to implement a function of normally accessing the second network by the terminal device serving as the DLNA RAC.

6. The terminal device, serving as the DLNA RAC, enables a DLNA function of the terminal device.

7. The terminal device advertises shared data to the first network and broadcasts, to the first network by using the shared data, information about the DLNA device recorded in the list instead of broadcasting information about a DLNA that is not recorded in the list.

8. For an M-SEARCH request sent by a DLNA device on the first network, the terminal device responds only with discovery information of the DLNA device included in the list.

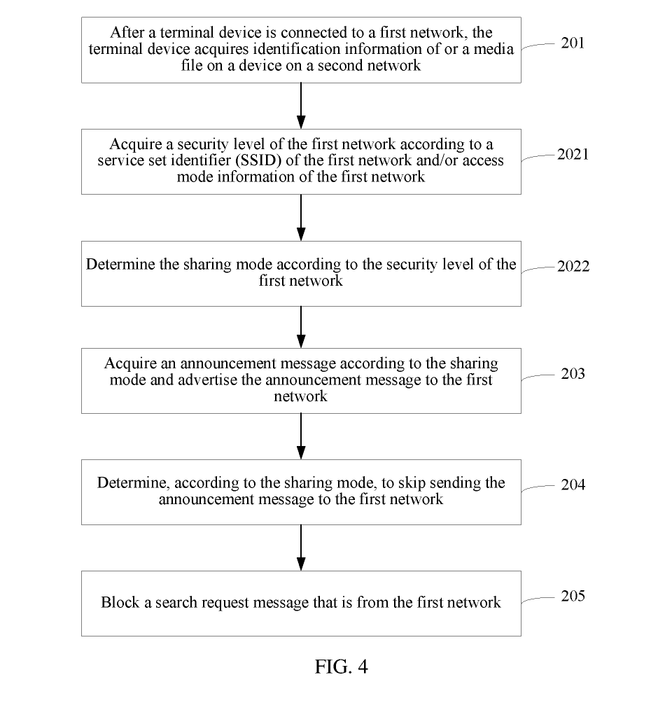

In this embodiment, as shown in FIG. 4, a specific implementation manner of step 202 may be:

2021: Acquire a security level of the first network according to a service set identifier (SSID) of the first network and/or access mode information of the first network.

A correspondence between the service set identifier and/or name information of a device and a network type may be stored on the terminal device. The terminal device may determine a network type of the first network according to the service set identifier of the first network, or according to the name information of the device on the first network, or according to both the service set identifier of the first network and the name information of the device on the first network, and then according to the stored correspondence between the service set identifier and/or the name information of the device and the network type. For example, the network type may include a secure private network, an unknown private network, a public network, and the like. SSID₁ is a home network of the user's friend, SSID₂ is a wireless local area network of a company, and SSID₃ is a wireless local area network in a public location, where a network type corresponding to SSID₁ is a secure private network, a network type corresponding to SSID₂ is an unknown private network, and a network type corresponding to SSID₃ is a public network of a fast-food restaurant. In this case, if the terminal device is on the home network of the friend, it may be determined, according to SSID₁, that a network type of the home network of the friend is the secure private network; if the terminal device is on the wireless local area network of the company, it may be determined, according to SSID₂, that a network type of the wireless local area network of the company is the unknown private network; if the terminal device is on the public network of the fast-food restaurant, it may be determined, according to SSID₃, that a network type of the public network of the fast-food restaurant is the public network. In addition, corresponding security levels may be set for different network types. Alternatively, a name of a device on the first network is “unknown”, or addresses of some devices on the first network are on a blacklist for a mobile terminal; in this case, a security level of the first network is determined as the lowest.

2022: Determine the sharing mode according to the security level of the first network.

For example, one security level may correspond to one advertising mode. For example, the security level of the first network may correspond to a trusted mode or a customized mode, where in the trusted mode, the terminal device needs to advertise data on all node devices on the second network to the first network, and in the customized mode, the terminal device needs to advertise data on a node device, on the second network, set by the user to the first network, and a node device, without being set by the user, on the second network, is not advertised to the first network.

A correspondence between a network type and a security level may be stored on the terminal device, and one network type corresponds to one security level. For example, a secure private network corresponds to security level 3, an unknown private network corresponds to security level 2, and a public network corresponds to security level 1. A correspondence between each security level and an advertising mode may be further stored on the terminal device. For example, security level 3 corresponds to a trusted mode or a customized mode, security level 2 corresponds to a temporary mode, and security level 1 corresponds to a common mode.

Optionally, before step 203 is executed, the method may further include: determining whether the security level of the first network is the lowest.

For example, an ascending order of security levels is: security level 1-security level 2-security level 3. When the security level of the first network is security level 1, a common mode may be used for the terminal device.

If the security level of the first network is not the lowest, the announcement message is acquired according to the sharing mode and is sent to the first network.

If the security level of the first network is the lowest, no shared data is advertised to the first network.

For example, in a common mode, the terminal device, serving as a DLNA RAC, may disable a DLNA function of the terminal device, broadcast no SSDP device or service discovery message to the first network, and make no response to an M-SEARCH request message sent by another DLNA device on the first network, so that the another DLNA device cannot discover the terminal device.

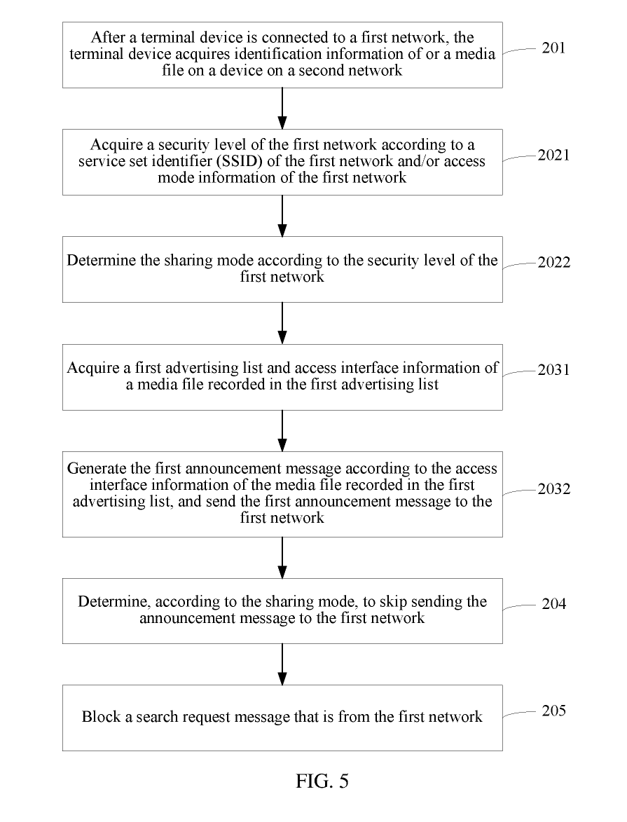

As shown in FIG. 5, a specific implementation manner of step 203 may be:

2031: Acquire a first advertising list and access interface information of a media file recorded in the first advertising list.

At least one media file on the mobile terminal is recorded in the first advertising list.

2032: Generate the first announcement message according to the access interface information of the media file recorded in the first advertising list, and send the first announcement message to the first network.

The first announcement message is generated by the mobile terminal according to the access interface information of the media file recorded in the first advertising list, so that after the mobile terminal advertises the first announcement message to the first network, the device on the first network may acquire a media file on the mobile terminal.

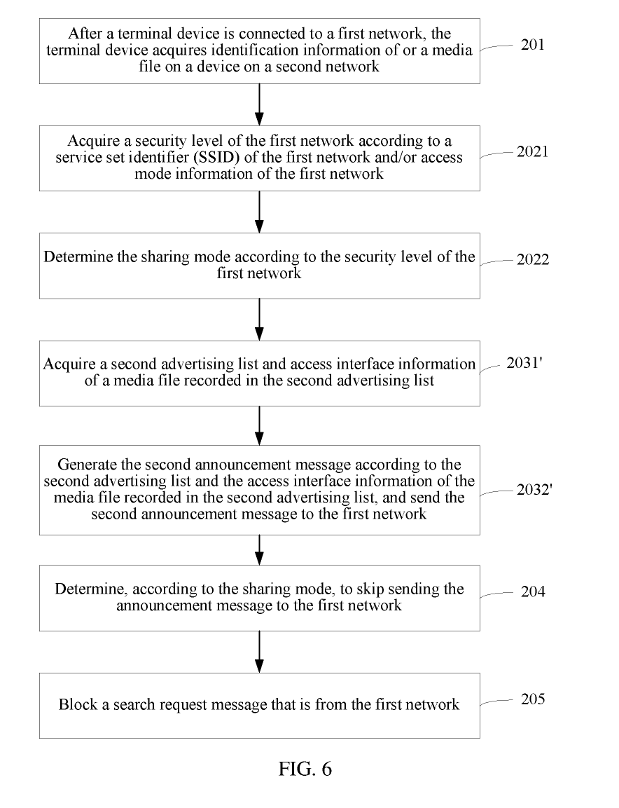

It is optional and parallel to 2031 and 2032 that, the terminal device is a node device on the second network, and then, as shown in FIG. 6, step 203 may be specifically:

2031′: Acquire a second advertising list and access interface information of a media file recorded in the second advertising list.

At least one of the identification information of the device on the second network and the media file on the second network is recorded in the second advertising list.

2032′: Generate the second announcement message according to the second advertising list and the access interface information of the media file recorded in the second advertising list, and send the second announcement message to the first network.

The second announcement message is generated by the mobile terminal according to the identification information of the device on the second network and the media file on the second network that are recorded in the second advertising list, so that after the mobile terminal advertises the second announcement message to the first network, the device on the first network may communicate with the device on the second network, and may acquire the media file on the second network.

Optionally, in this embodiment, with reference to the solution of step 2031 and step 2032 and the solution of step 2031′ and step 2032′, if the security level of the first network is not the lowest, a third advertising list may also be acquired, a third announcement message may be generated according to the third advertising list, and the third announcement message may be advertised to the first network. The identification information of the device on the second network, the media file on the second network, and the media file on the mobile terminal are recorded in the third advertising list, so that after the mobile terminal advertises the third announcement message to the first network, the device on the first network may communicate with the device on the second network, acquire the media file on the second network, and further acquire the media file on the mobile terminal.

According to the network access method provided in this embodiment of the present invention, a property of a network on which a terminal device is currently located can be determined, and the terminal device advertises, only when the network on which the terminal device is currently located is secure enough, a device and a media file on a remotely connected network to the network on which the terminal device is currently located; if the network on which the terminal device is currently located is not secure enough, the terminal device performs no advertising. Compared with a solution in the prior art in which all devices on a private network are advertised to an unfamiliar network to implement totally transparent transmission between different networks, in this embodiment of the present invention, security assessment may be performed on an unfamiliar network and whether a device and a media file on a private network and a media file on a terminal device need to be advertised to the unfamiliar network may be determined; therefore the terminal device can reduce a possibility of advertising a device on the private network to an insecure network, thereby reducing a possibility that a device on a private network is maliciously accessed by a device on an insecure network, ensuring user privacy, and improving security during network access. In addition, in this embodiment of the present invention, the terminal device may further select different advertising policies according to a property of the network on which the terminal device is currently located; therefore, the terminal device may use a more flexible security policy with respect to an unfamiliar network on which the terminal device is currently located, thereby reducing, when ensuring information sharing, a possibility that an important device on a private network is maliciously accessed by a device on an unfamiliar network.

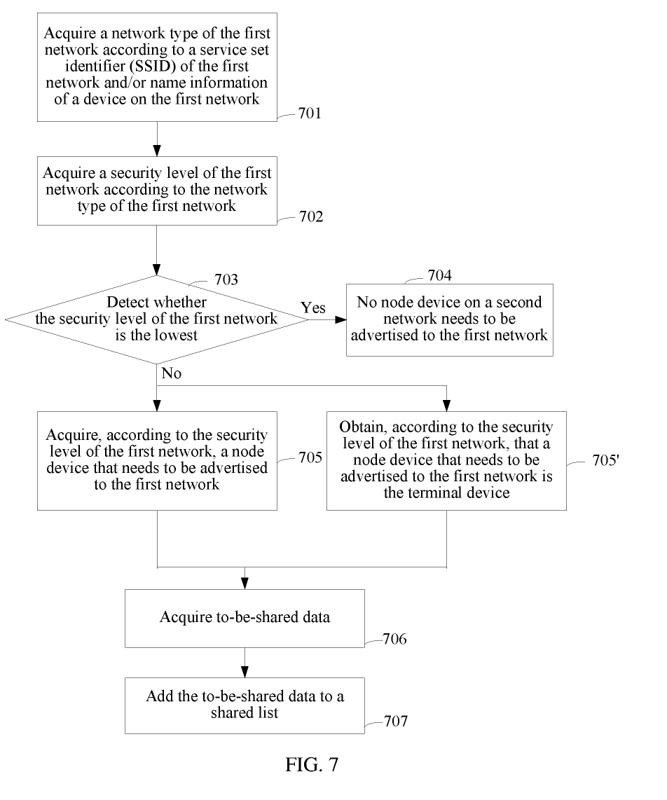

Optionally, in this embodiment, when determining, according to the property of the first network, the on a node device on the second network and that can be advertised to the first network, the terminal device may also set a limit to specific on the second network and that can be shared with the first network. Therefore, by using a solution shown in FIG. 7, the terminal device may set a limit to on a node device on the second network and that can be shared. The solution includes:

701: Acquire a network type of the first network according to a service set identifier (SSID) of the first network and/or name information of a device on the first network.

702: Acquire a security level of the first network according to the network type of the first network.

One network type corresponds to one security level.

703: Detect whether the security level of the first network is the lowest.

704: If the security level of the first network is the lowest, no data on node device on the second network needs to be advertised to the first network.

705. If the security level of the first network is not the lowest, acquire, according to the security level of the first network, data that is on the node device and that needs to be advertised to the first network.

705′: If the security level of the first network is not the lowest, obtain, according to the security level of the first network, that a node device that needs to be advertised to the first network is the terminal device.

Step 705′ is optional and is parallel to step 705, and the terminal device may perform either of 705′ and 705.

706: Acquire to-be-shared data.

The to-be-shared data is a part of data stored on a node device on the second network, and a node device having to-be-shared data is a node device that needs to advertise the to-be-shared data to the first network. For example, the terminal device advertises data on a node device on the second network to the first network in a temporary mode, a trusted mode, a customized mode, or the like, and the node device with data advertised and on the second network needs to accept an access request from a device on the first network and to share a part of data to the device on the first network. However, in actual application, although some node devices on the second network have been advertised, a user does not want to share all advertised data on the node device to a device on the first network. Therefore, the terminal device may group the advertised data on the node device according to procedures of steps 706 and 707 and use, as to-be-shared data, data that can be shared, and the advertised data, except the to-be-shared data, on the node device cannot be accessed by a device on the first network.

For example,

a DMS 1 and a DMS 2 on the second network are node devices that need to advertise document data to the first network, 1000 pieces of document data are stored on the DMS 1, and 500 pieces of audio data are stored on the DMS 2. The terminal device may extract, according to settings of a user, 10 pieces of document data from the DMS 1 as to-be-shared data and extract 20 pieces of audio data from the DMS 2 as to-be-shared data.

Alternatively, the terminal device may automatically group a part of data on a node device on the second network as to-be-shared data. For example, in 1000 pieces of document data stored on a DMS 1, 200 pieces of document data have a read-only attribute; when accessing document data, having a read-only attribute, on the DMS 1, a DLNA device on the first network can read but cannot modify the document data on the DMS 1, and therefore, it can be ensured, by sharing only the document data having a read-only attribute, that data on the DMS 1 is stable and cannot be tampered with in a process of being accessed; in this case, the terminal device may use the 200 pieces of document data having a read-only attribute as to-be-shared data; 100 of 500 pieces of picture data stored on a DMS 2 were modified four years ago, and a confidentiality demand of earlier picture data is lower; therefore, the terminal device may group picture data that was modified four years ago as to-be-shared data. Specifically, a time division limit may be set by a user or may be automatically determined by the terminal device according to a preset rule.

707: Add the to-be-shared data to a shared list.

The shared list is used to record data that can be accessed by the device on the first network, so that the device on the first network accesses the to-be-shared data according to the shared list.

In actual application of this embodiment, shared data may be advertised or notified in a manner of creating a shared list. The terminal device may notify a device on the first network of to-be-shared data in a manner of advertising a shared list, and the device on the first network has only a permission to access the to-be-shared data recorded in the shared list and has no permission to access data that is not recorded in the shared list.

According to the network access method provided in this embodiment of the present invention, a property of a network on which a terminal device is currently located can be determined, and the terminal device advertises, only when the network on which the terminal device is currently located is secure enough, a device and a media file on a remotely connected network to the network on which the terminal device is currently located; if the network on which the terminal device is currently located is not secure enough, the terminal device performs no advertising. Compared with a solution in the prior art in which all devices on a private network are advertised to an unfamiliar network to implement totally transparent transmission between different networks, in this embodiment of the present invention, security assessment may be performed on an unfamiliar network and whether a device and a media file on a private network and a media file on a terminal device need to be advertised to the unfamiliar network may be determined; therefore the terminal device can reduce a possibility of advertising a device on the private network to an insecure network, thereby reducing a possibility that a device on a private network is maliciously accessed by a device on an insecure network, ensuring user privacy, and improving security during network access. In addition, in this embodiment of the present invention, the terminal device may further select different advertising policies according to a property of the network on which the terminal device is currently located; therefore, the terminal device may use a more flexible security policy with respect to an unfamiliar network on which the terminal device is currently located, thereby reducing, when ensuring information sharing, a possibility that an important device on a private network is maliciously accessed by a device on an unfamiliar network. Therefore, compared with the prior art, this embodiment of the present invention can further protect an important device on a private network when ensuring that a user normally uses a network on which a terminal device is located, which further improves security during network access. In this embodiment of the present invention, the terminal device may further set a limit to a shared status of data on the private network, and after the device on the private network is advertised, can further protect the advertised data on the device, thereby reducing a possibility that the advertised data, involving user privacy, stored on the device is accessed. Therefore, compared with the prior art, this embodiment of the present invention can, when ensuring that a terminal device normally advertises a device on a private network, further reduce a possibility that important data on the private network is maliciously acquired, thereby further protecting user privacy and improving security during network access.

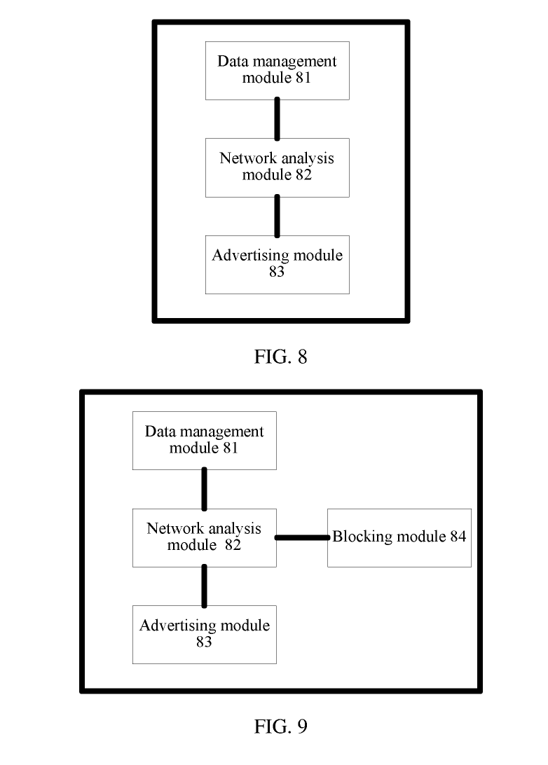

With reference to the network access method in the embodiments of the present invention, a network access apparatus is further provided, and as shown in FIG. 8, includes:

a data management module 81, configured to: after a terminal device is connected to a first network, acquire identification information of or a media file on a device on a second network;

a network analysis module 82, configured to determine a sharing mode according to a property of the first network, and determine, according to the sharing mode, shared data that needs to be sent to a device on the first network, where the shared data includes the device or media file on the second network, and/or a media file on the terminal device; and

an advertising module 83, configured to advertise an announcement message to the first network according to the sharing mode, where the announcement message includes at least one of the following: access interface information of the device on the second network, access interface information of the media file on the second network, and access interface information of the media file on the terminal device.

According to the network access apparatus provided in this embodiment of the present invention, a property of a network on which a terminal device is currently located can be determined, and a terminal device advertises, only when the network on which the terminal device is currently located is secure enough, a device and a media file on a remotely connected network to the network on which the terminal device is currently located; if the network on which the terminal device is currently located is not secure enough, the terminal device performs no advertising. Compared with a solution in the prior art in which all devices on a private network are advertised to an unfamiliar network to implement totally transparent transmission between different networks, in this embodiment of the present invention, security assessment may be performed on an unfamiliar network and whether a device and a media file on a private network and a media file on a terminal device need to be advertised to the unfamiliar network may be determined; therefore the terminal device can reduce a possibility of advertising a device on the private network to an insecure network, thereby reducing a possibility that a device on a private network is maliciously accessed by a device on an insecure network, ensuring user privacy, and improving security during network access. In addition, in this embodiment of the present invention, the terminal device may further select different advertising policies according to a property of the network on which the terminal device is currently located; therefore, the terminal device may use a more flexible security policy with respect to an unfamiliar network on which the terminal device is currently located, thereby reducing, when ensuring information sharing, a possibility that an important device on a private network is maliciously accessed by a device on an unfamiliar network. Therefore, compared with the prior art, this embodiment of the present invention can further protect an important device on a private network when ensuring that a user normally uses a network on which a terminal device is located, which further improves security during network access. In this embodiment of the present invention, the terminal device may further set a limit to a shared status of data on the private network, and after the device on the private network is advertised, can further protect the advertised data on the device, thereby reducing a possibility that the advertised data, involving user privacy, stored on the device is accessed. Therefore, compared with the prior art, this embodiment of the present invention can, when ensuring that a terminal device normally advertises a device on a private network, further reduce a possibility that important data on the private network is maliciously acquired, thereby further protecting user privacy and improving security during network access.

Optionally, as shown in FIG. 9, the apparatus may further include:

a blocking module 84, configured to determine, according to the sharing mode, to skip sending the announcement message to the first network; and block a search request message that is from the first network, where the search request message is used to request, from the mobile terminal, the access interface information of the device on the second network, the access interface information of the media file on the second network, or the access interface information of the media file on the terminal device.

The sharing mode includes: sending, by the terminal device, a first announcement message to the first network, where the first announcement message includes the access interface information of the device on the second network, the access interface information of the media file on the second network, and the access interface information of the media file on the terminal device; or sending, by the terminal device, a second announcement message to the first network, where the second announcement message includes the access interface information of the media file on the terminal device; or blocking, by the terminal device, the search request message that is from the first network.

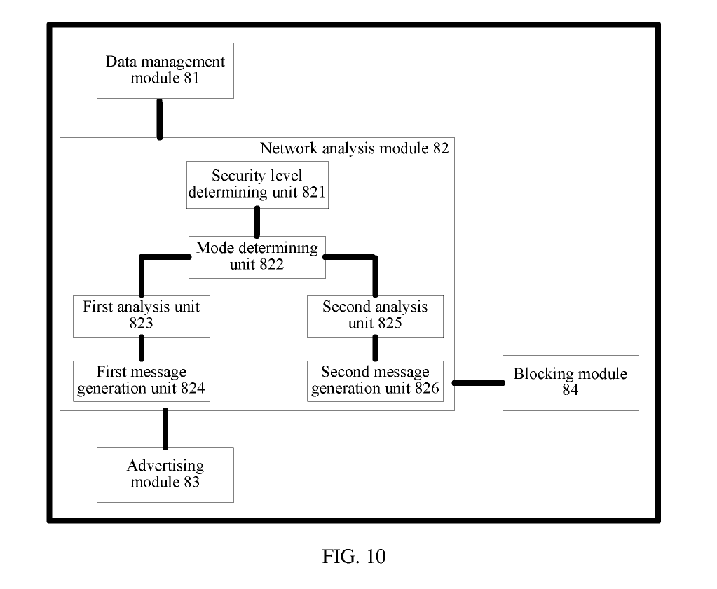

Further, as shown in FIG. 10, the network analysis module 82 includes:

a security level determining unit 821, configured to acquire a security level of the first network according to a service set identifier (SSID) of the first network and/or access mode information of the first network; and

a mode determining unit 822, configured to determine the sharing mode according to the security level of the first network.

Still further, the network analysis module 82 includes:

a first analysis unit 823, configured to acquire a first advertising list and access interface information of a media file recorded in the first advertising list, where at least one media file on the mobile terminal is recorded in the first advertising list; and

a first message generation unit 824, configured to generate the first announcement message according to the access interface information of the media file recorded in the first advertising list, and send the first announcement message to the first network.

The network analysis module 82 may also include:

a second analysis unit 825, configured to acquire a second advertising list and access interface information of a media file recorded in the second advertising list, where at least one of the identification information of the device on the second network and the media file on the second network is recorded in the second advertising list; and

a second message generation unit 826, configured to generate the second announcement message according to the second advertising list and the access interface information of the media file recorded in the second advertising list, and send the second announcement message to the first network.

According to the network access apparatus provided in this embodiment of the present invention, a property of a network on which a terminal device is currently located can be determined, and a terminal device advertises, only when the network on which the terminal device is currently located is secure enough, a device and a media file on a remotely connected network to the network on which the terminal device is currently located; if the network on which the terminal device is currently located is not secure enough, the terminal device performs no advertising. Compared with a solution in the prior art in which all devices on a private network are advertised to an unfamiliar network to implement totally transparent transmission between different networks, in this embodiment of the present invention, security assessment may be performed on an unfamiliar network and whether a device and a media file on a private network and a media file on a terminal device need to be advertised to the unfamiliar network may be determined; therefore the terminal device can reduce a possibility of advertising a device on the private network to an insecure network, thereby reducing a possibility that a device on a private network is maliciously accessed by a device on an insecure network, ensuring user privacy, and improving security during network access. In addition, in this embodiment of the present invention, the terminal device may further select different advertising policies according to a property of the network on which the terminal device is currently located; therefore, the terminal device may use a more flexible security policy with respect to an unfamiliar network on which the terminal device is currently located, thereby reducing, when ensuring information sharing, a possibility that an important device on a private network is maliciously accessed by a device on an unfamiliar network. Therefore, compared with the prior art, this embodiment of the present invention can further protect an important device on a private network when ensuring that a user normally uses a network on which a terminal device is located, which further improves security during network access. In this embodiment of the present invention, the terminal device may further set a limit to a shared status of data on the private network, and after the device on the private network is advertised, can further protect the advertised data on the device, thereby reducing a possibility that the advertised data, involving user privacy, stored on the device is accessed. Therefore, compared with the prior art, this embodiment of the present invention can, when ensuring that a terminal device normally advertises a device on a private network, further reduce a possibility that important data on the private network is maliciously acquired, thereby further protecting user privacy and improving security during network access.

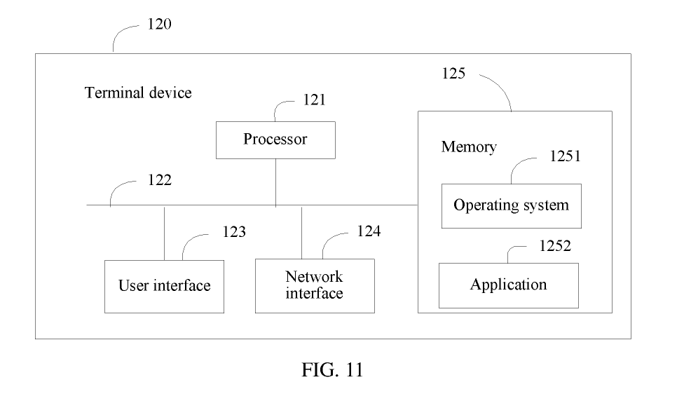

An embodiment of the present invention further provides a structure of a terminal device 120. As shown in FIG. 11, the terminal device 120 includes at least one processor 121, for example, a CPU, at least one network interface 124 or another user interface 123, a memory 125, and at least one communications bus 122. The communications bus 122 is configured to implement connection and communication between these components. Optionally, the user interface 123 is further included and includes a display, a keyboard, or a click device (such as a mouse, a trackball (trackball), a touchpad, or a touch display screen). The memory 125 may include a high speed RAM memory, or may include a non-volatile memory (non-volatile memory), for example, at least one magnetic disk memory. The memory 125 may optionally include at least one storage apparatus far away from the processor 121.

In some implementation manners, the memory 125 stores the following elements, an executable module or a data structure, or a subset thereof, or an extended set thereof:

an operating system 1251, including various system programs, and configured to implement various basic services and process hardware-based tasks; and

an application 1252, including various applications, and configured to implement various application services.

The application 1252 includes but is not limited to a data management module 81, a network analysis module 82, an advertising module 83, a blocking module 84, a security level determining unit 821, a mode determining unit 822, a first analysis unit 823, a first message generation unit 824, a second analysis unit 825, and a second message generation unit 826.

For specific implementation of the modules in the application 1252, reference is made to the corresponding modules in the embodiment shown in FIG. 8 to FIG. 10, and details are not described herein again.

Specifically, the processor 121 is configured to: after the terminal device is connected to a first network, acquire, by the terminal device, identification information of or a media file on a device on a second network;

determine a sharing mode according to a property of the first network, and determine, according to the sharing mode, shared data that needs to be sent to a device on the first network, where the shared data includes the device or media file on the second network, and/or a media file on the terminal device; and

advertise an announcement message to the first network according to the sharing mode, where the announcement message includes at least one of the following: access interface information of the device on the second network, access interface information of the media file on the second network, and access interface information of the media file on the terminal device.

The processor 121 may be further configured to:

determine, according to the sharing mode, to skip sending the announcement message to the first network; and block a search request message that is from the first network, where the search request message is used to request, from the mobile terminal, the access interface information of the device on the second network, the access interface information of the media file on the second network, or the access interface information of the media file on the terminal device.

The sharing mode may include: sending, by the terminal device, a first announcement message to the first network, where the first announcement message includes the access interface information of the device on the second network, the access interface information of the media file on the second network, and the access interface information of the media file on the terminal device; or sending, by the terminal device, a second announcement message to the first network, where the second announcement message includes the access interface information of the media file on the terminal device; or blocking, by the terminal device, the search request message that is from the first network.

The processor 121 may be specifically configured to acquire a security level of the first network according to a service set identifier (SSID) of the first network and/or access mode information of the first network; and determine the sharing mode according to the security level of the first network.

Optionally, the processor 121 may be specifically configured to acquire a first advertising list and access interface information of a media file recorded in the first advertising list, where at least one media file on the mobile terminal is recorded in the first advertising list; and generate the first announcement message according to the access interface information of the media file recorded in the first advertising list, and send the first announcement message to the first network.

Alternatively, the processor 121 may be specifically configured to acquire a second advertising list and access interface information of a media file recorded in the second advertising list, where at least one of the identification information of the device on the second network and the media file on the second network is recorded in the second advertising list; and generate the second announcement message according to the second advertising list and the access interface information of the media file recorded in the second advertising list, and send the second announcement message to the first network.

According to the terminal device provided in this embodiment of the present invention, a property of a network on which a terminal device is currently located can be determined, and a terminal device advertises, only when the network on which the terminal device is currently located is secure enough, a device and a media file on a remotely connected network to the network on which the terminal device is currently located; if the network on which the terminal device is currently located is not secure enough, the terminal device performs no advertising. Compared with a solution in the prior art in which all devices on a private network are advertised to an unfamiliar network to implement totally transparent transmission between different networks, in this embodiment of the present invention, security assessment may be performed on an unfamiliar network and whether a device and a media file on a private network and a media file on a terminal device need to be advertised to the unfamiliar network may be determined; therefore the terminal device can reduce a possibility of advertising a device on the private network to an insecure network, thereby reducing a possibility that a device on a private network is maliciously accessed by a device on an insecure network, ensuring user privacy, and improving security during network access. In addition, in this embodiment of the present invention, the terminal device may further select different advertising policies according to a property of the network on which the terminal device is currently located; therefore, the terminal device may use a more flexible security policy with respect to an unfamiliar network on which the terminal device is currently located, thereby reducing, when ensuring information sharing, a possibility that an important device on a private network is maliciously accessed by a device on an unfamiliar network. Therefore, compared with the prior art, this embodiment of the present invention can further protect an important device on a private network when ensuring that a user normally uses a network on which a terminal device is located, which further improves security during network access. In this embodiment of the present invention, the terminal device may further set a limit to a shared status of data on the private network, and after the device on the private network is advertised, can further protect the advertised data on the device, thereby reducing a possibility that the advertised data, involving user privacy, stored on the device is accessed. Therefore, compared with the prior art, this embodiment of the present invention can, when ensuring that a terminal device normally advertises a device on a private network, further reduce a possibility that important data on the private network is maliciously acquired, thereby further protecting user privacy and improving security during network access.

The embodiments in this specification are all described in a progressive manner, for same or similar parts in the embodiments, refer to these embodiments, and each embodiment focuses on a difference from other embodiments. Especially, a device embodiment is basically similar to a method embodiment, and therefore is described briefly; for related parts, refer to partial descriptions in the method embodiment.

A person of ordinary skill in the art may understand that all or some of the procedures of the methods in the embodiments may be implemented by a computer program instructing related hardware. The program may be stored in a computer-readable storage medium. When the program runs, the procedures of the methods in the embodiments are performed. The storage medium may include: a magnetic disk, an optical disc, a read-only memory (ROM), or a random access memory (RAM).

The foregoing descriptions are merely specific implementation manners of the present invention, but are not intended to limit the protection scope of the present invention. Any variation or replacement readily figured out by a person skilled in the art within the technical scope disclosed in the present invention shall fall within the protection scope of the present invention. Therefore, the protection scope of the present invention shall be subject to the protection scope of the claims.

What is claimed is:

1. A network access method, wherein the method is performed by a first device, comprising:
connecting to a first local area network (LAN);
acquiring at least one of identification information of a second device and a media file on the second device, wherein the second device is on a second LAN;
determining a sharing mode based on a property of the first LAN;
determining shared data based on the determined sharing mode, wherein the shared data comprises at least one of a media file on the first device, the identification information of the second device and the media file on the second device; and
sending a first announcement message to a third device on the first LAN in a case that the sharing mode is a first sharing mode, wherein the first announcement message comprises at least one of access interface information of the media file on the first device, access interface information of the second device and access interface information of the media file on the second device.

2. The network access method according to claim 1, further comprising:
sending a second announcement message to the third device in a case that the sharing mode is a second sharing mode, wherein the second announcement message comprises the access interface information of the media file on the first device.

3. The network access method according to claim 1, further comprising:
skipping sending the first announcement message or the second announcement message to the third device, and blocking a search request that is from the first network in a case that the sharing mode is a third sharing mode, wherein the search request is used to search for the first device and request, from the first device, at least one of the access interface information of the media file on the first device, the access interface information of the second device and the access interface information of the media file on the second device.

4. The network access method according to claim 1, wherein the determining a sharing mode based on a property of the first LAN comprises:
acquiring a security level of the first LAN based on at least one of a service set identifier (SSID) of the first LAN and access mode information of the first LAN; and
determining the sharing mode based on the security level of the first LAN.

5. The network access method according to claim 1, wherein the sending the first announcement message to the third device comprises:
acquiring a first list, wherein at least one of the identification information of the second device and the media file on the second device is recorded in the first list;
acquiring access interface information of the media file recorded in the first list;
generating the first announcement message based on the first list and the access interface information of the media file recorded in the first list; and
sending the first announcement message to the third device.

6. The network access method according to claim 2, wherein the sending the second announcement message to the third device comprises:
acquiring a second list, wherein at least one media file on the first device is recorded in the second list;
acquiring access interface information of a media file recorded in the second list;
generating the second announcement message based on the second list and the access interface information of the media file recorded in the second list; and
sending the second announcement message to the third device.

7. A terminal device, comprising:
a memory, configured to store a computer program code;
a processor, configured to execute the computer program code to:
connect to a first local area network (LAN);
acquire at least one of identification information of a first device and a media file on the first device, wherein the first device is on a second LAN;
determine a sharing mode based on a property of the first LAN;
determine shared data based on the determined sharing mode, wherein the shared data comprises at least one of a media file on the terminal device, the identification information of the first device and the media file on the first device; and
send a first announcement message to a second device on the first LAN in a case that the sharing mode is a first sharing mode, wherein the first announcement message comprises at least one of access interface information of the media file on the terminal device, access interface information of the first device and access interface information of the media file on the first device.

8. The terminal device according to claim 7, wherein the processor is further configured to:
send a second announcement message to the second device in a case that the sharing mode is a second sharing mode, wherein the second announcement message comprises the access interface information of the media file on the terminal device.

9. The terminal device according to claim 7, wherein the processor is further configured to:
skipping sending the first announcement message or the second announcement message to the second device, and blocking a search request that is from the first network in a case that the sharing mode is a third sharing mode, wherein the search request is used to search for the terminal device and request, from the terminal device, at least one of the access interface information of the media file on the terminal device, the access interface information of the first device and the access interface information of the media file on the first device.

10. The terminal device according to claim 7, wherein the determine a sharing mode based on a property of the first LAN comprises:
acquire a security level of the first LAN based on at least one of a service set identifier (SSID) of the first LAN and access mode information of the first LAN; and
determine the sharing mode based on the security level of the first LAN.

11. The terminal device according to claim 7, wherein the send the first announcement message to the second device comprises:
acquire a first list, wherein at least one of the identification information of the first device and the media file on the first device is recorded in the first list;
acquire access interface information of the media file recorded in the first list;
generate the first announcement message based on the first list and the access interface information of the media file recorded in the first list; and
send the first announcement message to the second device.

12. The terminal device according to claim 8, wherein the send the second announcement message to the second device comprises:
acquire a second list, wherein at least one media file on the terminal device is recorded in the second list;
acquire access interface information of a media file recorded in the second list;
generate the second announcement message based on the second list and the access interface information of the media file recorded in the second list; and
send the second announcement message to the second device.
